(19) United States
(12) Patent Application Publication
(10) Pub. No.: US 2015/0007110 A1
(43) Pub. Date: Jan. 1, 2015

(54) Method for Controlling Electronic Apparatus and Electronic Apparatus Thereof

(71) Applicant: Acer Inc., New Taipei City (TW)

(72) Inventors: Pei-Lin Chen, New Taipei City (TW); Ting-Feng Chou, New Taipei City (TW)

(73) Assignee: Acer Inc., New Taipei City (TW)

(21) Appl. No.: 14/048,087

(22) Filed: Oct. 8, 2013

(30) Foreign Application Priority Data
Jun. 26, 2013 (TW) 102122764

(51) Int. Cl. G06F 3/0484

(52) U.S. Cl. CPC G06F 3/04842
USPC 715/835

(57) ABSTRACT

A method for controlling an electronic apparatus is disclosed. The method includes: accepting an input item on the display module when a display module of an electronic apparatus is locked; accepting an instruction of selecting an input item; and executing an application corresponding to the input item. A corresponding electronic apparatus is also disclosed.

### FIELD OF INVENTION

The present invention relates to a method for controlling an electronic apparatus and an electronic apparatus, and more particularly relates to a method for controlling an electronic apparatus and an electronic apparatus capable of executing certain functions in lock mode.

### BACKGROUND

With advancements in technology and changes in consumer demands, new portable devices such as tablet personal computers, smart phones, personal digital assistants, and laptop computers are ubiquitous in society.

Most such portable devices have touch components to replace the original input devices. In touch technology, keyboards and monitors are integrated as the input interfaces of portable devices. To prevent users from unintentionally touching the touch device and therefore executing specific functions of the portable device or to protect the portable device from being used by an unauthorized third party, most portable devices have a user interface lock mode. When a portable device is in lock mode, the portable device cannot be controlled. After an unlock command is executed to cause the portable device to exit the lock mode, the portable device can then be controlled.

Although a lock mode and an unlock command increase the security of a portable device, the delay caused by needing to enter an unlock command first before using an application program can cause certain inconvenience in controlling the portable device. For example, a user may need to take notes while talking with someone. However, the user needs to perform the unlock command first to cause the device to exit the lock mode. By the time the note application program of a portable device is open, the user may have forgotten the idea to be noted. If notes can be taken without the device exiting the lock mode, efficiency and convenience may be increased.

Therefore, there is a need for an electronic apparatus and associated control method to solve the deficiency of conventional technology.

### SUMMARY OF INVENTION

A major objective of the present invention is to provide a method for controlling an electronic apparatus that is capable of executing specific functions even in lock mode.

Another objective of the present invention is to provide an electronic apparatus that is capable of executing specific functions even in lock mode.

To achieve the aforementioned objective, a method for controlling an electronic apparatus is provided. The method includes the following steps: when a display module of the electronic apparatus is locked, receiving an input item on the display module; receiving a selection instruction corresponding to all or a portion of the input item; and executing an application program corresponding to all or a portion of the input item selected.

According to an embodiment of the present invention, an electronic apparatus including a display module and a processing module is provided. When the display module is locked, the processing module receives an input item on the display module, receives a selection instruction corresponding to all or a portion of the input item, and executes an application program corresponding to all or a portion of the at least one input item selected.

### BRIEF DESCRIPTION OF DRAWINGS

FIG. 1 is a systematic diagram of an electronic apparatus according to an embodiment of the present invention;

FIG. 2 is a flowchart of a method for controlling an electronic apparatus according to an embodiment of the present invention;

FIG. 3A, FIG. 3B, FIG. 3C and FIG. 3D illustrate a first embodiment of the method for controlling an electronic apparatus of the present invention; and

FIG. 4A, FIG. 4B and FIG. 4C illustrate a second embodiment of the method for controlling an electronic apparatus of the present invention.

### DETAILED DESCRIPTION

For clear explanation of the aforementioned and other objectives, features and advantages of the present invention, detailed descriptions are provided along with associated drawings to describe embodiments of the present invention as follows.

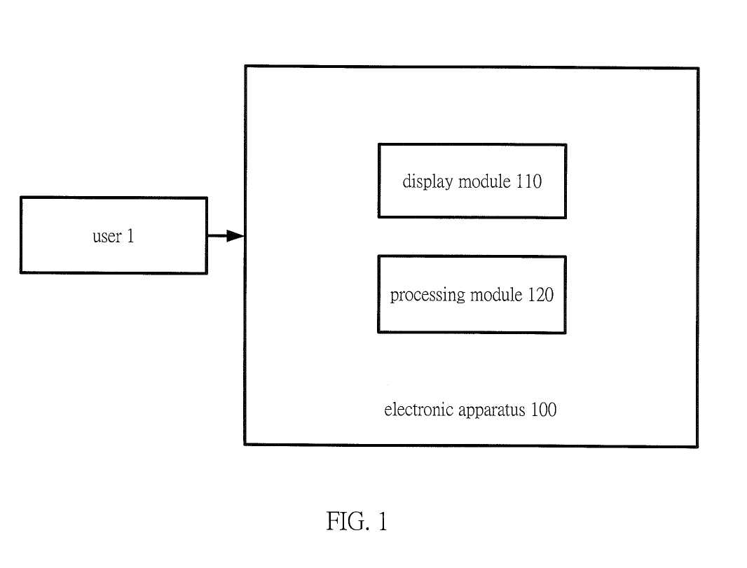

Please refer to FIG. 1, which is a systematic diagram of an electronic apparatus according to the first embodiment of the present invention. The electronic apparatus 100 includes a display module 110 and a processing module 120. When the display module 110 of the electronic apparatus 100 is locked, a user 1 can still input commands on the display module 110 by using the method for controlling an electronic apparatus of the present invention so that the processing module 120 executes corresponding application programs according to the input command.

In one embodiment of the present invention, the electronic apparatus 100 may be a mobile phone, but the present invention is not limited thereto. The electronic apparatus may also be a personal digital assistant (PDA), a global positioning system (GPS), a tablet computer or other devices. Please also note that the method for controlling an electronic apparatus of the present invention may be embedded in an operating system or made as an application program installed on the electronic apparatus. Again, the present invention is not limited to these exemplified forms.

As illustrated in FIG. 1, according to a first embodiment of the present invention, the electronic apparatus 100 includes a display module 110 and a processing module 120. Please note that each module may be implemented by hardware devices, software programs, firmware or their combination and may also be implemented by circuits or other proper forms. In addition, each module may be implemented as a single form and may be implemented as a combination form. Also, although preferred embodiments are explained here, not every possible variation is described for brevity. Nevertheless, persons skilled in the art should recognize that the aforementioned modules or elements are not always necessary. For implementing the present invention, other detailed conventional modules or components may be also used. Each module or element may be omitted or modified, and other modules or components may be between any two modules.

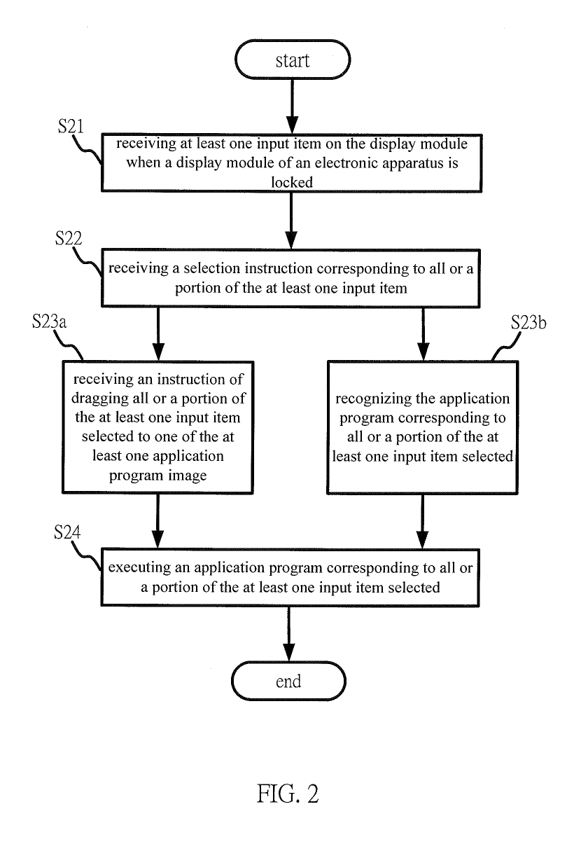

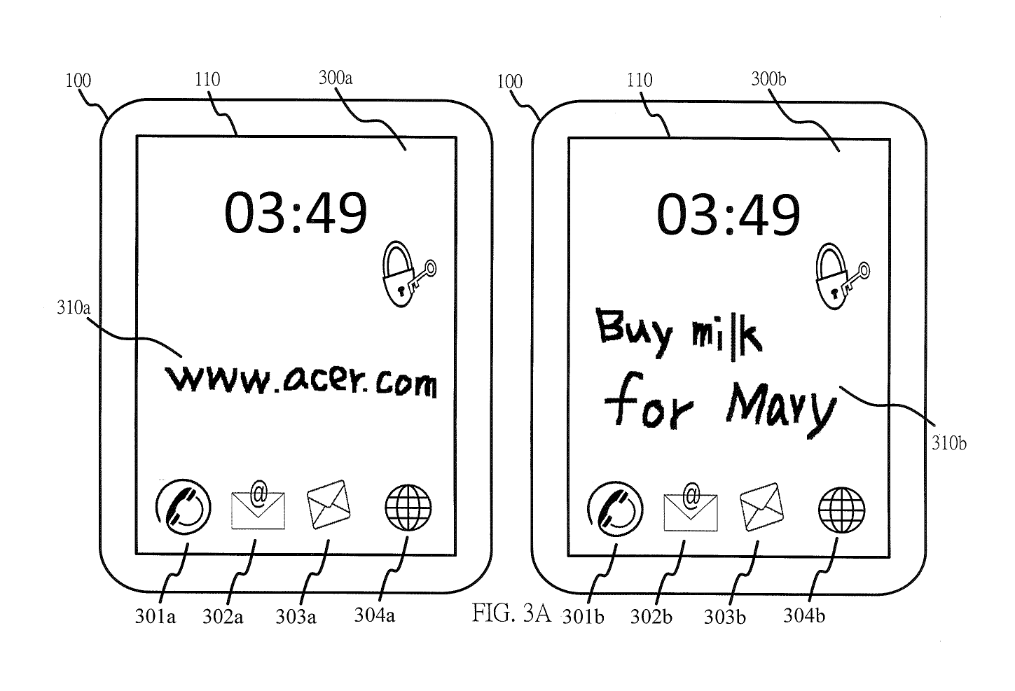

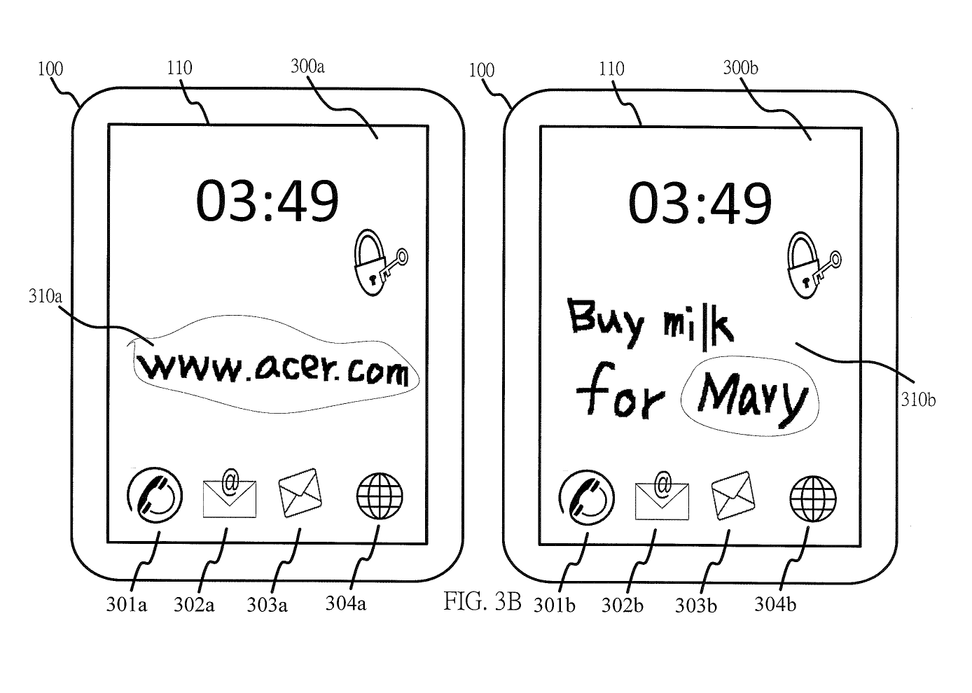

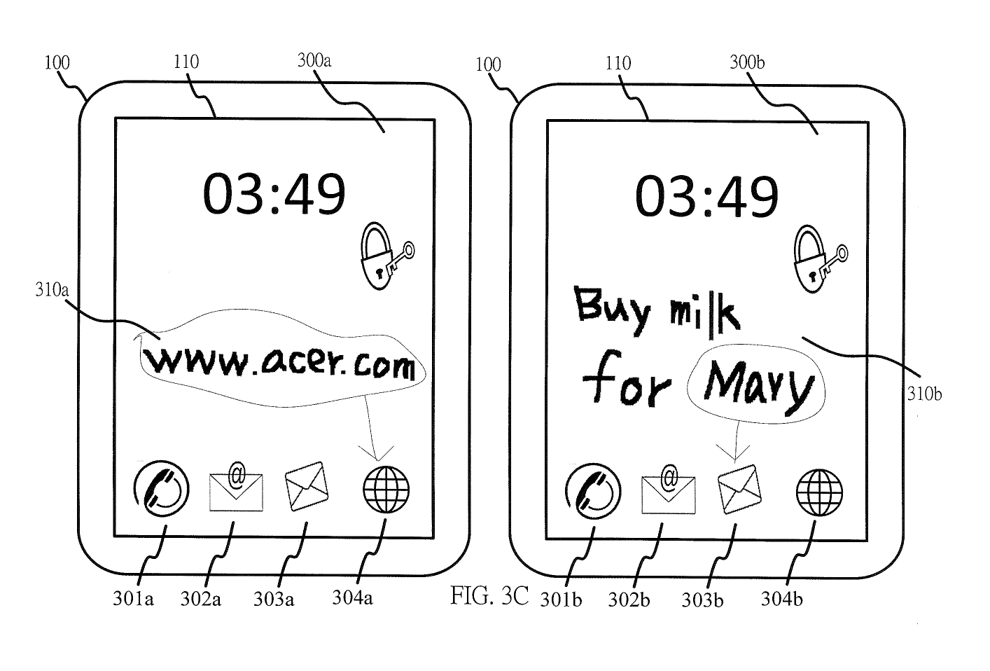

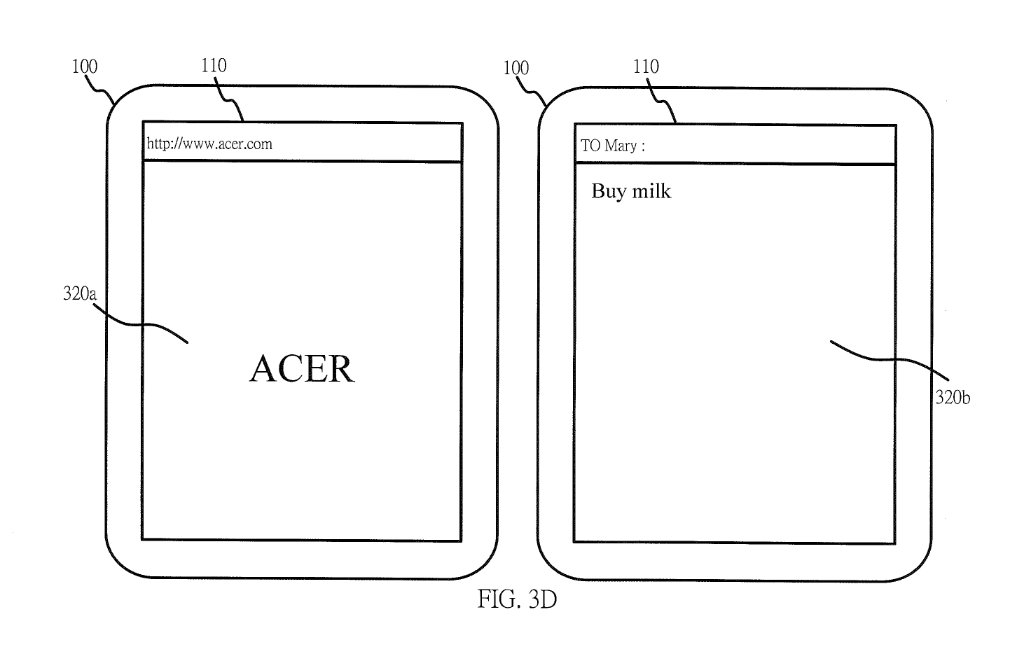

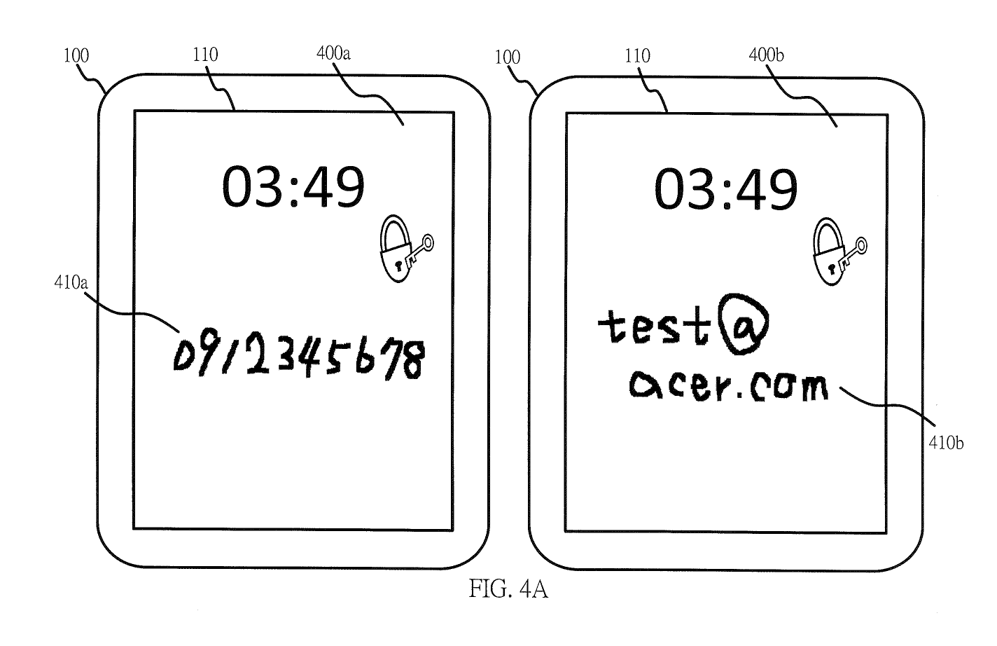

Please refer to FIG. 2, which is a flowchart illustrating a method for controlling an electronic apparatus according to an embodiment of the present invention. Please refer to FIG. 1, FIG. 3A, FIG. 3B, FIG. 3C and FIG. 3D, which illustrate a first embodiment of the present invention. The electronic apparatus 100 of FIG. 1 is illustrated for explaining the method for controlling an electronic apparatus according to the present invention. However, please note that the method for controlling an electronic apparatus of the present invention is not limited to the usage in the electronic apparatus 100 illustrated in FIG. 1.

First, step S21 is performed: receiving at least one input item on the display module when a display module of an electronic apparatus is locked.

Please refer to FIG. 3A. When the display module 110 is in lock mode, a user interface 300a or a user interface 300b is displayed on the display module. A plurality of application program images are displayed on the user interface 300a and 300b respectively, and each application program image corresponds to an application program. For example, the application program images 301a and 301b correspond to a dial application program. The application program images 302a and 302b correspond to an e-mail application program. The application program images 303a and 303b correspond to a short message application program.

The application program images 304a and 304b correspond to a browser application program. Please note that the applications on the electronic apparatus 100 are not limited to the above examples. A user 1 may input a command on the display module and the electronic apparatus 100 may manage associated processing by the processing module 120.

According to one embodiment, the display module 110 is a touch display module. The user 1 may use fingers, touch pens or other devices to input commands on the display module 110. As illustrated in FIG. 3A, the input item 310a is a URL, and the input item 310b is a text message. According to one embodiment of the present invention, the input item may be a text input but may also be a number or an image.

Next, step S22 is performed: receiving a selection instruction corresponding to all or a portion of the at least one input item.

Please refer to FIG. 3B. The user 1 may select all or a portion of the input items 310a and 310b. The electronic apparatus 100 uses the processing module 120 to receive the selection instruction. According to an embodiment of the present invention, as illustrated in FIG. 3B but not presented here as a limitation, the user 1 may use fingers, touch pens or other devices to select all or a portion of the input items 310a and 310b to complete the selection instruction.

Next, step S23a is performed: receiving an instruction of dragging all or a portion of the at least one input item selected to one of the at least one application program image.

After all or a portion of the input item 310a or the input item 310b is selected, the user 1 may use fingers, touch pens or other devices to drag the selected portion of the input item 310a to one of the application program images 301a, 302a, 303a and 304a, or to drag the selected portion of the input item 310b to one of the application images 301b, 302b, 303b and 304b to open the designated application program for execution of a function. The electronic apparatus 100 uses the processing module 120 to receive the instruction.

Next, step S24 is performed: executing an application program corresponding to all or a portion of the at least one input item selected.

Last, the processing module 120 executes an application program corresponding to the selected input item. As illustrated in FIG. 3D, if the input item 310a is dragged to the application program image 304a (corresponding to the browser application program) or the input item 310b is dragged to the application program image 303b (corresponding to the text message application program), the processing module 120 automatically executes the browser application program or the text message application program.

According to one embodiment of the present invention, when the processing module 120 executes the application program corresponding to the selected input item, it can also automatically input all or a portion of the input item to corresponding fields of the operating interface of the application program. As illustrated in FIG. 3D, when the processing module 120 opens a text message application program, it automatic fills a corresponding field of the text message application program with the content of the input item 310b.

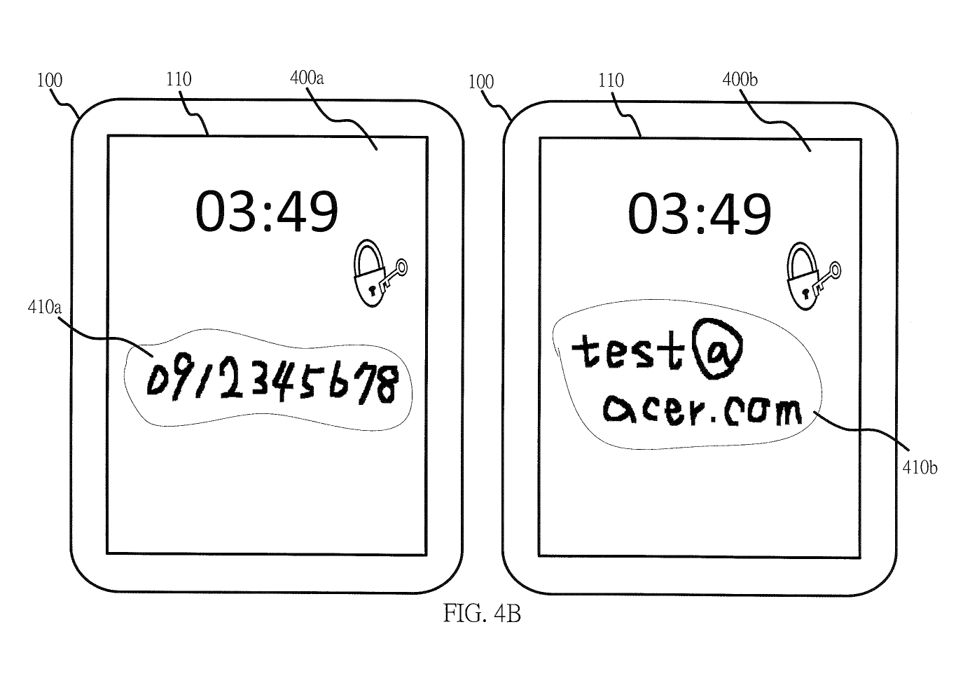

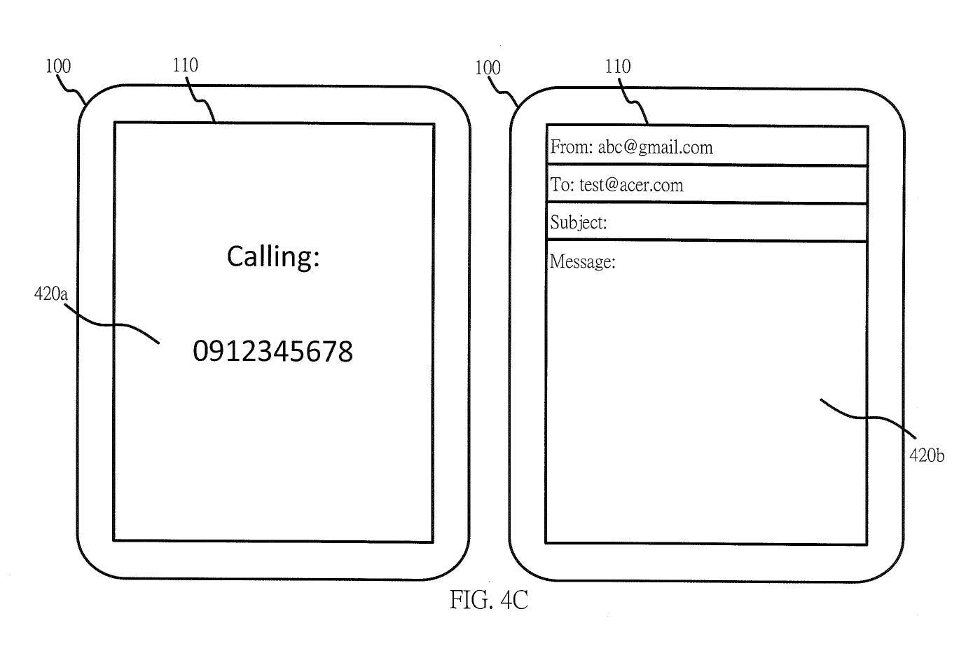

Next, please refer to FIG. 4A, FIG. 4B, and FIG. 4C, which illustrate a second embodiment of the present invention. The difference between the first embodiment and the second embodiment is that the processing module 120 automatically identifies the application program corresponding to the selected input item. The user 1 does not need to drag the selected input item to an application program image.

First, step S21 is performed: receiving at least one input item on the display module when a display module of an electronic apparatus is locked.

Please refer to FIG. 4A. The display module 110 displays a user interface 400a or a user interface 400b. No application program images are displayed on the user interface 400a or the user interface 400b.

As illustrated in FIG. 4A, the input item 410a on the display module 110 input by the user 1 is a phone number, and the input item 410b is an e-mail address.

Next, step S22 is performed: receiving a selection instruction corresponding to all or a portion of the at least one input item.

Please refer to FIG. 4B. The user 1 may select all or a portion of the input items 410a and 410b. The electronic apparatus 100 uses the processing module 120 to receive the selection instruction.

Next, step S23b is performed: recognizing the application program corresponding to all or a portion of the at least one input item selected.

After selection of all or a portion of the input item 410a or the input item 410b, the processing module 120 automatically identifies an application program corresponding to the input item 410a or the input item 410b. According to one embodiment of the present invention, the processing module 120 is able to automatically recognize the format of the input item and identify corresponding application programs according to the format of the input item selected. As illustrated in FIG. 4B and 4C, in which the input item 410a is a 10-digit number with specific starting numbers, the corresponding application is identified as a dial application program. The input item 410b is a text string in the format of an e-mail address, so the corresponding application program is identified as an e-mail application program. In this embodiment, it is not necessary to drag the input item to one of the application program images as is necessary in step 23a, and the corresponding application program is still able to be identified.

Last, step S24 is performed: executing an application program corresponding to all or a portion of the at least one input item selected.

Finally, the processing module 120 executes the identified application program corresponding to the input item selected. As illustrated in FIG. 4C, the processing module 120 automatically executes the dial application program or the e-mail application program.

Please note that the method for controlling an electronic apparatus as mentioned above is not limited to executing the steps in the order described above. The order of steps order may be changed so long as the objectives of the present invention can still be achieved.

The above descriptions of embodiments of the present invention are presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for controlling an electronic apparatus, comprising:
receiving at least one input item on a display module of the electronic apparatus when the display module of the electronic apparatus is locked;
receiving a selection instruction corresponding to all or a portion of the at least one input item; and
executing an application program corresponding to all or a portion of the at least one input item selected.

2. The method of claim 1, further comprising:
identifying the application program corresponding to all or a portion of the at least one input item selected.

3. The method of claim 1, wherein the display module displays at least one application program image, the method further comprising:
receiving an instruction of dragging all or a portion of the at least one input item selected to one of the at least one application program image.

4. The method of claim 1, further comprising:
automatically inputting all or a portion of the at least one input item to at least one corresponding field of an operating interface of the application program.

5. The electronic apparatus control method of claim 1, wherein the display module is a touch display module.

6. An electronic apparatus, comprising:
a display module; and
a processing module for executing the following steps:
receiving at least one input item on the display module when the display module is locked;
receiving a selection instruction corresponding to all or a portion of the at least one input item; and
executing an application program corresponding to all or a portion of the at least one input item selected.

7. The electronic apparatus of claim 6, wherein the processing module is further used for identifying the application program corresponding to all or a portion of the at least one input item selected.

8. The electronic apparatus of claim 6, wherein at least one application program image is displayed on the display module, and the processing module is further used for receiving an instruction of dragging all or a portion of the at least one input item selected to one of the at least one application program image.

9. The electronic apparatus of claim 6, wherein the processing module is further used for automatically inputting all or a portion of the at least one input item into at least one corresponding field of an operating interface of the application program.

10. The electronic apparatus of claim 6, wherein the display module is a touch display module.
